(19) United States
(12) Patent Application Publication
(10) Pub. No.: US 2009/0021142 A1
(43) Pub. Date: Jan. 22, 2009

(54) LIGHT EMISSION DEVICE AND DISPLAY DEVICE

(76) Inventors: Zin-Min Park, Yongin-si (KR); Seung-Joon Yoo, Yongin-si (KR); Jung-Ho Kang, Yongin-si (KR); Su-Kyung Lee, Yongin-si (KR); Won-Il Lee, Yongin-si (KR)

Correspondence Address: CHRISTIE, PARKER & HALE, LLP, PO BOX 7068, PASADENA, CA, 91109-7068, US

(21) Appl. No.: 12/103,851

(22) Filed: Apr. 16, 2008

(30) Foreign Application Priority Data
Jul. 20, 2007 (KR) 10-2007-0072831

(51) Int. Cl. H01J 1/62

(52) U.S. Cl. 313/503

(57) ABSTRACT

A light emission device and a display device provided with the light emission device are provided. The light emission device includes first and second substrates opposing each other. An electron emission unit is arranged on the first substrate. A light emission unit is provided on the second substrate and has an active area and an inactive area surrounding the active area. An arcing preventing member is formed on the inactive area. The arcing preventing member is formed to satisfy the condition: 0.3≦H/W≦1.0, where W is a width of the active area and H is a height of the arcing preventing member.

### CROSS-REFERENCE TO RELATED APPLICATION

This application claims priority to and the benefit of Korean Patent Application No. 10-2007-0072831 filed on Jul. 20, 2007, in the Korean Intellectual Property Office, the entire content of which is incorporated herein by reference.

### BACKGROUND OF THE INVENTION

1. Field of the Invention

The present invention relates to display devices, and, more particularly, to a light emission device with an arcing damage prevention structure.

2. Description of Related Art

Generally, electron emission elements are classified into those using hot cathodes as an electron emission source, and those using cold cathodes as the electron emission source.

Electron emission elements using the cold cathodes include: Field Emitter Array (FEA) electron emission elements, Surface-Conduction-Emission (SCE) electron emission elements, Metal-Insulator-Metal (MIM) electron emission elements, and Metal-Insulator-Semiconductor (MIS) electron emission elements.

Although the different types of electron emission elements differ in a detailed structure and an electron emission principle, all of them include electron emission regions and driving electrodes for controlling the electron emission of the electron emission regions and thus emit electrons from the electron emission regions.

The electron emission elements are arrayed on a first substrate to form an electron emission unit. The electron emission unit is combined with a second substrate on which a light emission unit having a phosphor layer and an anode electrode is formed, thereby constituting an electron emission display.

The electron emission device may be used as a display by itself or as a light source of a passive type (a non-self-emissive) display. A liquid crystal display is well known as a typical passive type display requiring the light source.

The liquid crystal display includes a display panel. The display panel receives light from the light emission device, and, by using a liquid crystal layer, either transmits or blocks the light, thereby displaying a predetermined image.

Recently, a light emission device having a surface light source using a cold cathode electron emission source has been developed to replace a cold cathode fluorescent lamp (CCFL) which is a line light source and a light emitting diode (LED) which is a point light source.

A typical light emission device using the cold cathode electron emission source includes a vacuum vessel having first and second substrates that face each other and are sealed together. An interior of the vacuum vessel is exhausted during a manufacturing process of the light emission device to be kept to a vacuum state.

However, impurity gas generated from an internal structure during the manufacturing process of the light emission device may not be completely exhausted but still remains in the interior of the vacuum vessel of the light emission device.

The residual gas in the vacuum vessel is ionized by electrons emitted from the electron emission regions and the ionized gas emits new electrons. These new electrons ionize the residual gas again. When this process is repeated, arcing may occur in the light emission device.

The arcing generates a flash of high current. The high current causes damage of the internal structure, particularly an anode electrode, of the light emission device.

### SUMMARY OF THE INVENTION

Exemplary embodiments in accordance with the present invention provide a light emission device for preventing damage to an internal structure which may be caused by arcing.

In an exemplary embodiment of the present invention, a light emission device includes first and second substrates opposing each other. An electron emission unit is arranged on the first substrate. A light emission unit is provided on the second substrate and has an active area and an inactive area surrounding the active area. An arcing preventing member is formed on the inactive area. The arcing preventing member satisfies the following condition: 0.3≦H/W≦1.0, where, W is a width of the active area and H is a height of the arcing preventing member.

The active area may be divided into a plurality of sections and the arcing preventing member may be formed corresponding to a top surface shape of the inactive area and surrounds each of the sections of the active area.

The light emission unit may include a phosphor layer formed on the active area and an anode electrode formed on a surface of the phosphor layer.

In addition, the light emission unit may further include a black layer formed on the inactive area and the phosphor layers are formed in openings formed in the black layer.

Each of the openings of the black layer may be formed in a rectangular shape and the width W corresponds to a shorter side of the opening.

The arcing preventing member may be formed of a material selected from the group consisting of an insulation material, a resistive material, and a conductive material.

The electron emission unit may include Field Emitter Array (FEA) electron emission elements, Surface-Conduction-Emission (SCE) electron emission elements, Metal-Insulator-Metal (MIM) electron emission elements, or Metal-Insulator-Semiconductor (MIS) electron emission elements.

In another exemplary embodiment of the present invention, a display device includes a display panel for displaying an image. A light emission device emits light toward the display panel. The light emission device includes first and second substrates opposing each other. An electron emission unit is arranged on the first substrate. A light emission unit is provided on the second substrate and has an active area and an inactive area surrounding the active area. An arcing preventing member is formed on the inactive area. The arcing preventing member satisfies the condition: 0.3≦H/W≦1.0, where, W is a width of the active area and H is a height of the arcing preventing member.

The active area may be formed in a rectangular shape and the width W corresponds to a shorter side of the active area.

The light emission unit may include a phosphor layer formed on the active area and an anode electrode formed on a surface of the phosphor layer.

The display panel may be a liquid crystal panel.

### BRIEF DESCRIPTION OF THE DRAWINGS

FIG. 1 is a partially exploded perspective view of a light emission device according to a first exemplary embodiment of the present invention.

FIG. 2 is a partial sectional view of the light emission device of FIG. 1 when assembled.

FIG. 3 is a partial top plan view of a light emission unit of the light emission device of FIGS. 1 and 2.

FIG. 4 is a partially exploded perspective view of a light emission device according to a second exemplary embodiment of the present invention.

FIG. 5 is a partial top plan view of the light emission device of FIG. 4.

FIG. 6 is a partial sectional view of a modified example of the first and second exemplary embodiments.

FIG. 7 is an exploded perspective view of a display device using the light emission device of the second exemplary embodiment as a light source according to an exemplary embodiment of the present invention.

### DETAILED DESCRIPTION OF THE EMBODIMENTS

All devices that can emit light to an external side are regarded as light emission devices for exemplary embodiments of the present invention. Therefore, all of displays that can transmit information by displaying symbols, letters, numbers, and images are regarded as light emission devices. The light emission devices may be used as light sources that can provide light to a light receiving (non-emissive) display panel.

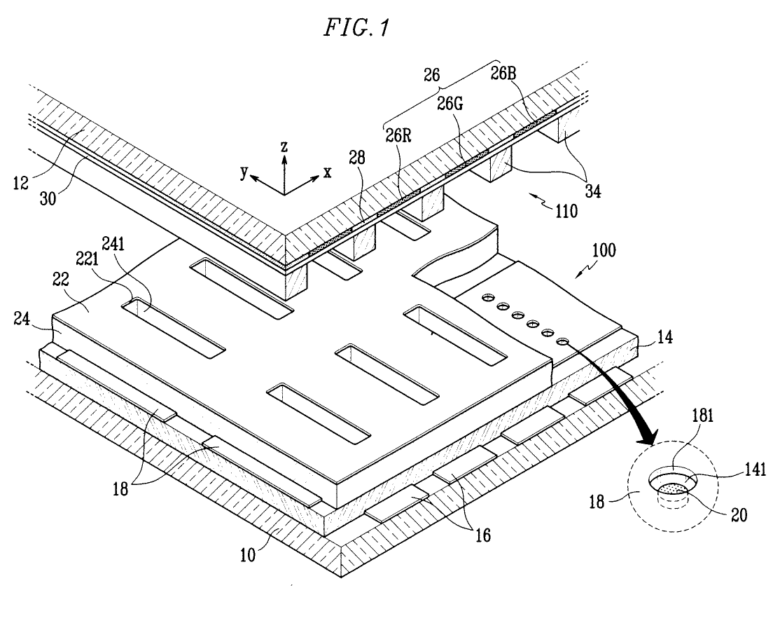

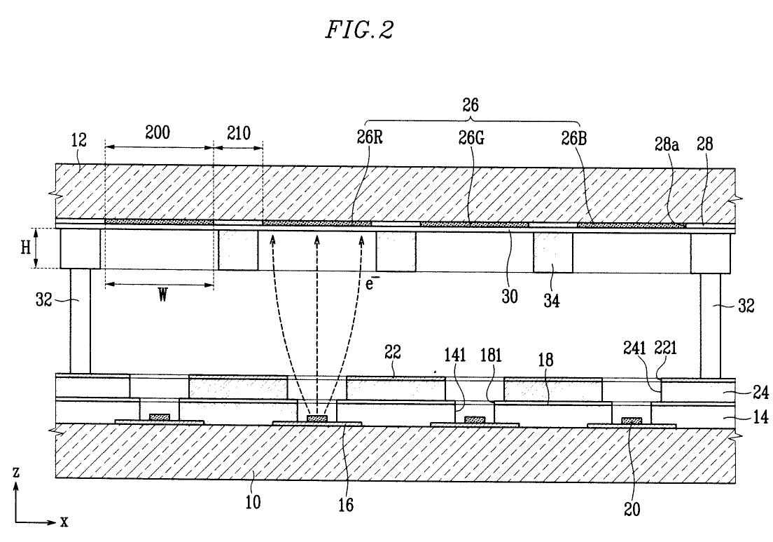

Referring to FIGS. 1 and 2, a light emission device includes first and second substrates 10, 12 facing each other and spaced apart in a parallel. A sealing member (not shown) is provided between peripheries of the first and second substrates 10, 12 to seal them together and thus form a vacuum vessel.

The interior of the vacuum vessel is exhausted during the manufacturing process of the light emission device and kept to a degree of vacuum of about 10⁻⁶ Torr.

An electron emission unit 100 having electron emission elements is provided on an inner surface of the first substrate 10 and a light emission unit 110 for emitting the visible light is provided on an inner surface of the second substrate 12.

The electron emission unit 100 and the light emission unit 110 within the vacuum vessel constitute the light emission device.

The electron emission unit 100 may include Field Emitter Array (FEA) electron emission elements, Surface Conduction Emitter (SCE) electron emission elements, Metal-Insulator-Metal (MIM) electron emission elements, or Metal-Insulator-Semiconductor (MIS) electron emission elements. The electron emission unit 100 further includes electron emission regions and driving electrodes to emit electrons toward the second substrate 12 by each pixel defined on the first substrate 10.

In the present first exemplary embodiment, a case where the electron emission unit 100 has the FEA electron emission elements is explained as an example.

Referring to FIGS. 1, 2 and 3, the electron emission unit 100 includes first and second electrodes 16, 18 that are arranged in stripe patterns whose directions intersect each other with a first insulation layer 14 interposed therebetween and electron emission regions 20 that are electrically connected to the first electrodes 16 or to the second electrodes 18.

When the electron emission regions 20 are formed on the first electrodes 16, the first electrodes 16 function as cathode electrodes applying a current to the electron emission regions 20 and the second electrodes 18 function as gate electrodes for inducing the electron emission by forming an electric field using a voltage difference from the cathode electrodes. Alternatively, when the electron emission regions 20 are formed on the second electrodes 18, the second electrodes 18 function as the cathode electrodes and the first electrodes 16 become the gate electrodes.

Openings 181, 141 are respectively formed in the second electrodes 18 and the first insulation layer 14 at respective regions where the directions of the first and second electrodes 16, 18 intersect each other, thereby partly exposing the surface of the first electrodes 16. In the depicted embodiment electron emission regions 20 are located on the first electrodes 16 in the openings 181, 141.

The electron emission regions 20 are formed of a material capable of emitting electrons when an electric field is applied thereto under a vacuum atmosphere, such as a carbon-based material or a nanometer-sized material. For example, the electron emission regions 20 may include at least one of the materials selected from the group consisting of: carbon nanotubes, graphite, graphite nanofibers, diamonds, diamond-like carbon, fullerene C₆₀, silicon nanowires, and a combination thereof.

Alternatively, the electron emission regions may be formed in a tip structure formed of a molybdenum-based material or a silicon-based material.

A third electrode 22 functioning as a focusing electrode may be formed above the second electrodes 18 and the first insulation layer 14. A second insulation layer 24 is located under the third electrode 22 to insulate the second electrodes 18 from the third electrodes 22. Openings 221 and openings 241 are respectively formed in the third electrodes 22 and the second insulation layer 24 to allow electron beams to pass therethrough.

The openings 221 of the third electrodes 22 may be formed corresponding to the respective electron emission regions 20 to individually converge the electrons emitted from each of the electron emission regions 20. Alternatively, each of the openings 221 of the third electrodes 22 may be formed to correspond to two or more electron emission regions 20 to generally converge the electrons emitted from the electron emission regions 20. In FIGS. 1 and 2, the second case is illustrated.

The light emission unit 110 includes phosphor layers 26, such as red, green, and blue phosphor layers 26R, 26G, 26B, are formed on the inner surface of the second substrate 12 with a predetermined distance therebetween. A black layer 28 for enhancing a screen contrast is formed between the phosphor layers 26. The phosphor layers 26 are arranged such that each of the red, green, and blue phosphor layers 26R, 26G, 26B corresponds to a single pixel area.

An anode electrode 30 formed of a metal layer such as an aluminum (Al) layer is formed on the phosphor layers 26 and the black layer 28. The anode electrode 30 is an acceleration electrode that receives a high voltage to place the phosphor layer 26 at a high electric potential state. The anode electrode 30 functions to enhance the screen luminance by reflecting the visible light, which is emitted from the phosphor layer 26 to the first substrate 10, toward the second substrate 12.

Alternatively, the anode electrode may be formed of a transparent electrode such as indium tin oxide (ITO). In this case, the anode electrode is located between the second substrate 12 and the surfaces of the phosphor layer and black layers 26, 28. Still alternatively, the anode electrode may be formed including both of the metal layer and the transparent conductive layer. The metal layer may be provided as a metal bag.

Disposed between the first and second substrates 10, 12 are spacers 32 that are able to withstand a compression force applied to the vacuum vessel and to uniformly maintain a gap between the first and second substrates 10, 12.

In the above-described structure of the light emission device, a portion emitting visible light toward the second substrate 12 will be referred as an active area 200 and a portion that is not related with the emission of the visible light and is surrounded by the active area 200 will be referred as an inactive area 210.

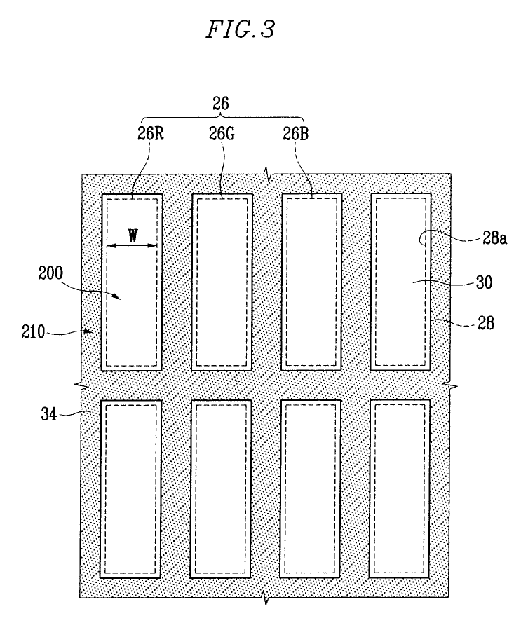

FIG. 3 is a partial top plan view of the light emission unit of the light emission device of FIGS. 1 and 2.

As shown in FIG. 3, when openings 28a of the black layer 28 are filled with phosphor layers 26, a portion corresponding to the openings of the 28a of the black layer 28 becomes the active area 200 and a portion corresponding to the black layer becomes the inactive area 210.

An arcing preventing member 34 is formed on the inactive area 210 and protrudes toward the first substrate 10. The arcing preventing member 34 may be formed on a surface of the anode electrode opposing the first substrate 10, surrounding the phosphor layers 26 along the black layer 28. The arcing preventing member 34 may be formed of an insulation material, a resistive material, or a conductive material.

Furthermore, in an exemplary embodiment the arcing preventing member 34 is formed to satisfy Equation 1:

0.3≦H/W≦1.0

where, as seen in FIG. 2, W is a width of the active area 200, and H is a height of the arcing preventing member 34.

In the first exemplary embodiment, as shown in FIG. 3, as the active area 200 is formed in a rectangular shape, the width W corresponds to a shorter side of the active area 200.

Table 1 below shows a voltage where arcing occurs as H/W is changed. In Table 1, the voltage where arcing occurs is a measured voltage where arcing occurs for the first time while a gradually increasing driving voltage of the anode electrode is input to the anode electrode.

TABLE 1

H/W

| | 0 | 0.1 | 0.3 | 0.7 |
|---|---|---|---|---|
| Voltage (kV) | 4 | 4 | 5.5 | 8 |
| where arcing occurs | | | | |

Referring to Table 1, the voltage where arcing occurs when H/W is 0 and 0.1 is shown to be 4 kV. If an ordinary light emission device is driven so that arcing of the anode electrode occurs over 5 kV, a minimum H/W would be 0.3. In this case the light emission device is stably driven at a driving voltage of the anode electrode of 5 kV, because the voltage where arcing occurs is 5.5 kV.

Furthermore, display properties of the light emission device, for instance screen luminance, could be improved when the driving voltage of the anode electrode is over 7 kV. Therefore, in the exemplary embodiment, the H/W could be set at 0.7. In this case when the light emission device is driven with a driving voltage of the anode electrode of 7 kV to enhance the display properties, the voltage where arcing occurs would be 8 kV.

When H/W exceeds 1, it is difficult to manufacture an arcing preventing member and the efficiency of emission is lowered due to a collision between some of the electrons and the phosphor layer. Therefore, in an exemplary embodiment the maximum H/W is 1.

The width of the arcing preventing member 34 may be equal to or smaller than that of the inactive area 210 so as not to extend into the active area 200. In FIGS. 1 through 3, a case where the arcing preventing member 34 has a smaller width than the inactive area 210 is illustrated as an example.

The arcing preventing member 34 may be formed through a pattern-printing process, a printing-etching process, or a printing-exposing process. When the pattern-printing process is used, a mixture containing solid contents such as vehicles is printed on the anode electrode 30 using a pattern mask, thereby forming the arcing preventing member 20. This process is not illustrated in the drawings.

In the printing-etching process, the mixture containing the solid contents is deposited on an entire surface of the anode electrode 30 and a photosensitive material is deposited on the mixture layer, after which a portion of the deposited photosensitive material, which corresponds to the phosphor layers 26, are removed using an exposing mask. Next, the deposited mixture is etched using the remaining photosensitive material as a mask and the remaining photosensitive material is removed, thereby forming the arcing preventing member 34

In the printing-exposing process, a photosensitive material is added to the mixture and this mixture is deposited on an entire surface of the anode electrode 30. A portion of the deposited mixture, which corresponds to the phosphor layers 26, is removed using an exposing mask, thereby forming the arcing preventing member 20.

Referring back to FIG. 2, a case where the arcing preventing member 34 is in contact with the spacers 32, i.e., the spacers 32 are located on the arcing preventing member 34, is illustrated as an example. However, the present invention is not limited to this case.

That is, although not shown in the drawings, the arcing preventing member and the spacers may be located in the inactive area without overlapping each other.

The above-described light emission device is driven by applying predetermined driving voltages to the first, second, and third electrodes 16, 18, 22 and the anode electrode 30.

For example, one of the first and second electrodes 16, 18 has a scan driving voltage applied so as to function as a scan electrode and the other has a data driving voltage applied so as to function as a data electrode.

The third electrode 22 has a voltage applied that is needed for the convergence of the electron beams, for example, 0V or a negative direct current voltage of several to tens of volts. The anode electrode 30 has a voltage applied that is needed for accelerating the electron beams, for example, a positive direct current voltage of hundreds through thousands of volts.

Electric fields are formed around the electron emission regions 20 at the pixels where the voltage difference between the first and second electrodes 16, 18 is equal to or greater than the threshold value, and thus electrons are emitted from the electron emission regions 20. The emitted electrons collide with a corresponding portion of the phosphor layer 26 of the relevant pixels by being attracted by the high voltage applied to the anode electrode 30, thereby exciting the phosphor layer 26.

In the present exemplary embodiment, the arcing preventing member 34 prevents the arcing by absorbing secondary electrons which are a cause of arcing. Accordingly, the arcing preventing member 34 protects structures of the first substrate 10 and the second substrate 12, particularly the anode electrode 30 and the phosphor layer 26 that have high voltages input thereto. Further, the arcing preventing member 34 diminishes damage to those structures if the arcing occurs in a vacuum vessel of the light emission device.

In the foregoing exemplary embodiment, one example is shown where the light emission device functions as a display by itself. However, the light emission device may be used as a surface light source of a light receiving (non-emissive) type display.

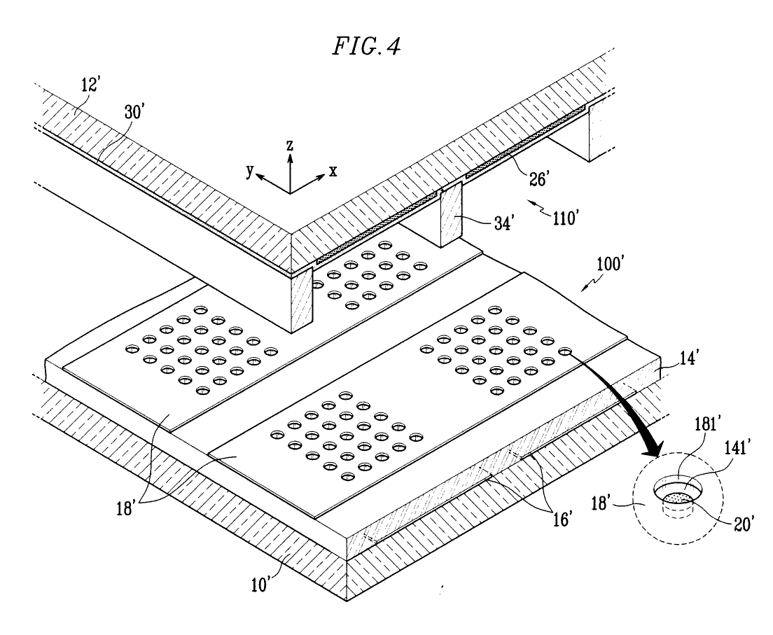

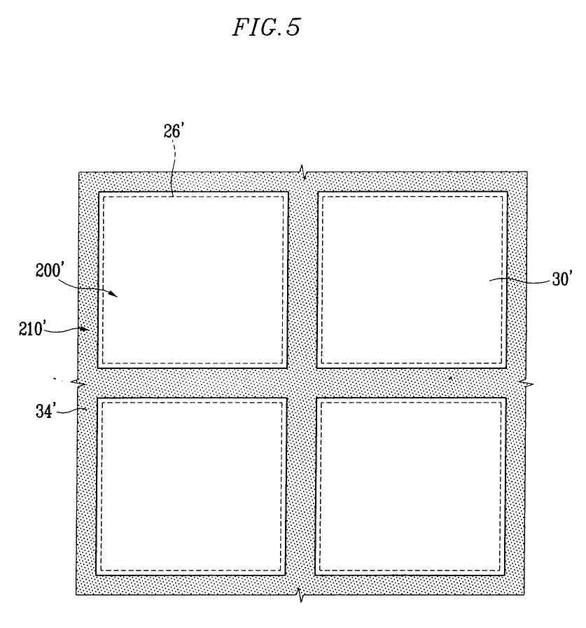

FIG. 4 is a partially exploded perspective view of a light emission device according to a second exemplary embodiment of the present invention, and FIG. 5 is a partial top plane view of the light emission device of FIG. 4.

Referring to FIGS. 4 and 5, a basic structure of a light emission device of this second exemplary embodiment is identical to that of the first embodiment except for the size of each of the pixel regions, the number of the electron emission regions formed on each unit pixel, and the structure of the light emission unit. This will be described hereinafter.

In an electron emission unit 100′ of this second exemplary embodiment, each of areas where the direction of the first electrodes 16′ intersect with the direction of the second electrodes 18′ corresponds to a single pixel region. Alternatively, two or more of the intersecting areas may correspond to the single pixel region. In this case, two or more of the first electrodes 16′ and/or two or more of the second electrodes 18′, which correspond to the single pixel region, are electrically connected to each other to receive a common driving voltage.

The light emission unit 110′ includes phosphor layers 26′ located on a surface of the second substrate 12′ and an anode electrode 30′.

The phosphor layer 26′ may be realized using a white phosphor layer. At this point, the phosphor layer 26′ may be formed in a single body on the surface of the second substrate 12′ or formed in a predetermined pattern in which a plurality of the white phosphor layers are positioned respectively corresponding to the pixel areas.

Alternatively, a phosphor layer may be realized by a combination of red, green, and blue phosphor layers, which are patterned in each pixel region.

In FIGS. 4 and 5, a case where the white layers are positioned corresponding to the respective pixel regions is illustrated as an example.

The anode electrode 30′ may be formed of a metal layer such as an aluminum (Al) layer covering the phosphor layers 26′. The anode electrode 30′ is an acceleration electrode that receives a high voltage to maintain the phosphor layer 26′ at a high electric potential state to attract electron beams. The anode electrode 30′ also functions to enhance luminance by reflecting visible light. That is, visible light that is emitted from the phosphor layer 26′ toward the first substrate 10′ is reflected by the anode electrode 30′ toward the second substrate 12′.

In the above-described structure of the light emission device, a portion emitting visible light toward the second substrate 12′ will be referred as an active area 200′ and a portion that is not related with the emission of the visible light and is surrounded by the active area 200′ will be referred as an inactive area 210′.

In a structure in which the phosphor layers 26′ are individually formed corresponding to the respective pixel regions as shown in FIG. 5, a portion where the phosphor layers 26′ are located becomes an active area 200′ and a portion surrounding the phosphor layers 26′ becomes an inactive area 210′.

An arcing preventing member 34′ is formed on the inactive area 210. Since the arcing preventing member 34′ has a same structure as that of the first exemplary embodiment, a detailed description thereof will be omitted herein.

When the first and second electrodes 16′, 18′ are applied with predetermined driving voltages, electric fields are formed around the electron emission regions 20′ at the pixels where the voltage difference between the first and second electrodes 16′, 18′ is equal to or greater than the threshold value, and thus electrons are emitted from the electron emission regions 20′. The emitted electrons collide with a corresponding portion of the phosphor layer 26′ of the relevant pixels by being attracted by the high voltage applied to the anode electrode 30′, thereby exciting the phosphor layer 26′. The light emission intensity of the phosphor layer 26′ for each pixel corresponds to an amount of the electrons emitted from the corresponding pixel.

Here, a distance between the first and second substrates 10′, 12′ may be greater than that between the first and second substrates 10, 12 of the first exemplary embodiment.

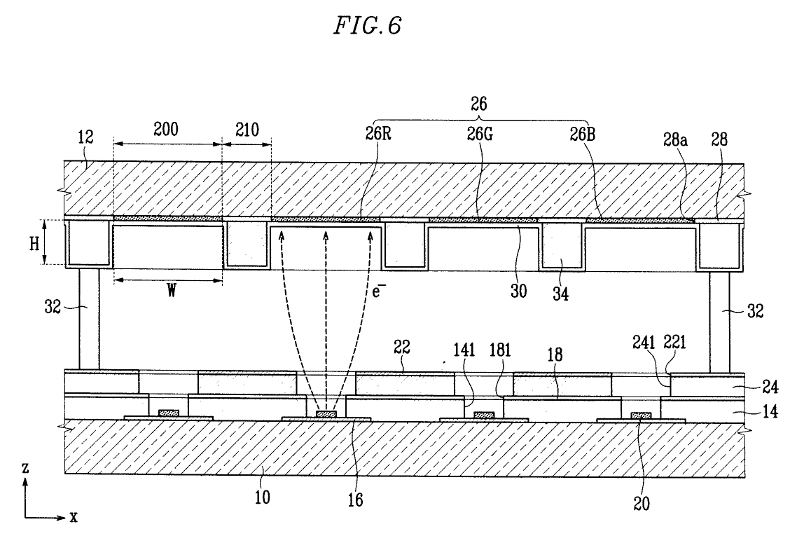

FIG. 6 is a partial sectional view of a modified example of the first and second exemplary embodiments. Although an arcing preventing member of this modified example may be applied to both of the first and second exemplary embodiments, a case where the arcing preventing member is applied to the first exemplary embodiment will be now be described.

Referring to FIG. 6, the structure of a light emission device of this modified example is basically identical to that of the first exemplary embodiment except that an arcing preventing member 34 is formed between the black layer 28 and the anode electrode 30. That is, the arcing preventing member 34 is formed on the black layer 28 and the anode electrode 30 are formed while covering the arcing preventing member 34 and the phosphor layers 26.

According to this modified example, since the arcing preventing member 30 are formed on the second substrate 12 in advance of forming the anode electrode 30, the damage of the anode electrode, which may be caused by the arcing preventing member 34 during the forming of the arcing preventing member 34, can be prevented.

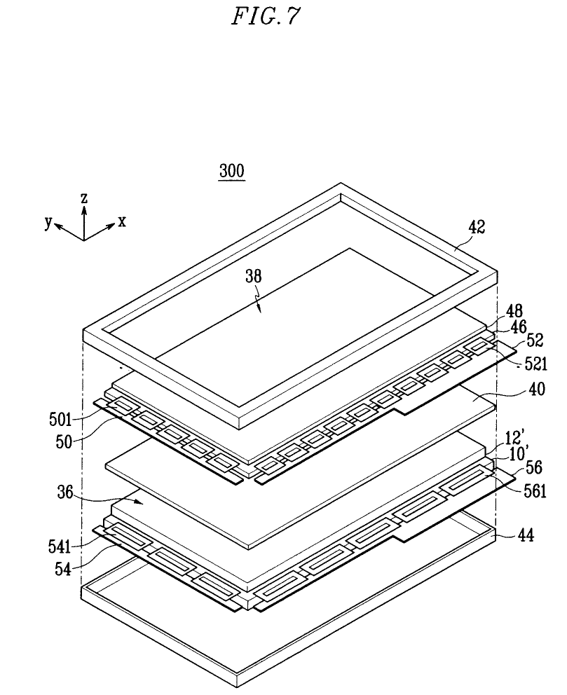

FIG. 7 is an exploded perspective view of a display using the light emission device of the second exemplary embodiment as a light source according to an exemplary embodiment of the present invention. A display illustrated in FIG. 5 is only provided as an example, not limiting the present invention.

Referring to FIG. 7, a display device 300 includes a light emission device 36 and a display panel 38 located in front of the light emission device 36. A diffuser plate 40 for uniformly diffusing light emitted from the light emission device 36 to the display panel 38 may be located between the light emission device 36 and the display panel 38. The diffuser plate 40 is spaced apart from the light emission device 36 by a predetermined distance. A top chassis 42 is located in front of the display panel 38 and a bottom chassis 44 is located in rear of the light emission device 36.

A liquid crystal panel or other light receiving type (not-emissive type) display panels may be used as the display panel 38. In the following description, a case where the display panel 38 is the liquid crystal panel will be explained as an example.

The display panel 38 includes a thin film transistor (TFT) substrate 46 having a plurality of TFTs, a color filter substrate 48 located above the TFT substrate 46, and a liquid crystal layer (not shown) formed between the substrates 46, 48. Polarizing plate (not shown) is attached on the color filter substrate 48 and the TFT substrate 46 to polarize the light passing through the display panel 38.

Data lines are connected to respective source terminals of the TFTs and gate lines are connected to respective gate terminals of the TFTs. Pixel electrodes formed of a transparent conductive layer are connected to respective drain terminals of the TFTs. When electric signals are input from first printed circuit boards 50, 52 to the gate and data lines, electric signals are input to the gate and source terminals of the TFTs. The TFTs are turned on or off according to the input signals so that electric signals required for driving the pixel electrodes are output to the drain terminals.

The color filter substrate 48 may have red, green and blue pixels that can emit colored light as the light passes through the color filter substrate 48. A common electrode formed of a transparent conductive material is formed on an entire surface of the color filter substrate 48. When the TFT is turned on by applying electric power to the gate and source terminals, an electric filed is formed between the pixel electrode and the common electrode of the color filter substrate 48. The twisting angle of liquid crystal molecular between the TFT substrate 46 and the color filter substrate 48 is varied, in accordance of which, the light transmittance of the corresponding pixel is varied.

The first printed circuit boards 50, 52 of the display panel 38 are respectively connected to driving IC packages 501, 521. In order to drive the display panel 38, the gate printed circuit board 50 transmits a gate driving signal and the data printed circuit board 52 transmits a driving signal.

The light emission device 36 includes a plurality of pixels, the number of which is less than the number of pixels of the display panel 38 so that one pixel of the light emission device 36 corresponds to two or more of the pixels of the display panel 38. Each pixel of the light emission device 36 emits light in response to a highest gray level among gray levels of the corresponding pixels of the display panel 38. The light emission device 36 can represent a 2-8 bit gray at each pixel.

For convenience, the pixels of the display panel 38 are referred as first pixels and the pixels of the light emission device 36 are referred as second pixels. The first pixels corresponding to one second pixel is referred as a first pixel group.

Describing a driving process of the light emission device 36, a signal control unit (not shown) controlling the display panel 38 detects the highest gray level of the first pixel group, operates a gray level required for emitting light from the second pixel in response to the detected high gray level, converts the operated gray level into digital data, and generates a driving signal of the light emission device 36 using the digital data. The driving signal of the light emission device 36 includes a driving signal and a data driving signal.

Second scan and data printed circuit boards 54, 56 of the light emission device 36 are respectively connected to driving integrated circuit packages 541, 561. In order to drive the light emission device 36, the scan printed circuit board assembly transmits the scan driving signal while the data printed circuit board assembly transmits a data driving signal. One of first and second electrodes 16′, 18′ is applied with the scan driving signal and the other is applied with the data driving signal.

When the image is displayed by the first pixel group corresponding to the second pixel, the second pixel of the light emission device 36 emits light with a predetermined gray level by synchronizing with the first pixel group. As described above, the light emission device 36 provides a proper intensity of light to the pixels of the display panel 38 by independently controlling the intensity of the light emission of each corresponding pixel thereof. The display device 300 of the present exemplary embodiment can enhance the dynamic contrast of the screen and improve the image quality.

Although exemplary embodiments of the present invention have been described in detail hereinabove, it should be clearly understood that many variations and/or modifications of the basic inventive concept taught herein still fall within the spirit and scope of the present invention, as defined by the appended claims and their equivalents.

What is claimed is:

1. A light emission device comprising:
a first substrate and a second substrate opposing each other;
an electron emission unit on the first substrate;
a light emission unit on the second substrate, the light emission unit having an active area and an inactive area surrounding the active area; and
an arcing preventing member on the inactive area,
wherein the arcing preventing member satisfies the following condition:
0.3≦H/W≦1.0
where, W is a width of the active area and H is a height of the arcing preventing member in a direction from the second substrate to the first substrate.

2. The device of claim 1, wherein the active area is divided into a plurality of sections and the arcing preventing member corresponds to a top surface shape of the inactive area and surrounds each of the sections of the active area.

3. The device of claim 2, wherein the light emission unit comprises:
a phosphor layer on the active area; and
an anode electrode on a surface of the phosphor layer.

4. The device of claim 3, wherein the light emission unit further comprises a black layer on the inactive area and the phosphor layer in openings in the black layer.

5. The device of claim 4, wherein each of the openings of the black layer has a rectangular shape and the width W corresponds to a shorter side of an opening.

6. The device of claim 1, wherein the arcing preventing member is a material selected from the group consisting of an insulation material, a resistive material and a conductive material.

7. The device of claim 1, wherein the electron emission unit includes electron emission elements selected from the group consisting of field emitter array electron emission elements, surface-conduction-emission electron emission elements, metal-insulator-metal electron emission elements, and metal-insulator-semiconductor electron emission elements.

8. A display device comprising
a display panel for displaying an image, and
a light emission device for emitting light toward the display panel,
wherein the light emission device comprises:
a first substrate and a second substrate opposing each other;
an electron emission unit on the first substrate;
a light emission unit on the second substrate, the light emission unit having an active area and an inactive area surrounding the active area; and
an arcing preventing member on the inactive area,
wherein the arcing preventing member satisfies the condition: 0.3≦H/W≦1.0, where, W is a width of the active area and H is a height of the arcing preventing member in a direction from the second substrate to the first substrate.

9. The device of claim 8, wherein the active area has a rectangular shape and the width W corresponds to a shorter side of the active area.

10. The device of claim 8, wherein the light emission unit comprises:
a phosphor layer formed on the active area; and
an anode electrode formed on a surface of the phosphor layer.

11. The device of claim 8, wherein the display panel is a liquid crystal panel.

12. A light emission device comprising:
a first substrate and a second substrate opposing each other;
an electron emission unit on the first substrate;
a light emission unit on the second substrate, the light emission unit having an active area and an inactive area surrounding the active area; and
an arcing preventing member protruding from the inactive area toward the first substrate, the arcing preventing member having a width W corresponding to a width of the active areas and a protrusion height H toward the first substrate,
wherein the arcing preventing member is sized such that a H/W ratio is within the range 0.3≦H/W≦1.0, and
the H/W ratio is selected from within the range 0.3≦H/W≦1.0 to set a desired anode driving voltage to be less than an arcing voltage.

13. The light emission device of claim 12, wherein the desired anode driving voltage is less than 5.5 kV.

14. The light emission device of claim 12, wherein the desired anode driving voltage is less than 8 kV.

15. The light emission device of claim 12, wherein the arcing preventing member is selected from the group consisting of an insulation material, a resistive material and a conductive material.
